(19) United States
(12) Patent Application Publication
(10) Pub. No.: US 2008/0199677 A1
(43) Pub. Date: Aug. 21, 2008

(54) BEARING WALL BOARD AND A METHOD OF PRODUCING THE SAME

(75) Inventor: Masanori Ukai, Nagoya-Shi (JP)

Correspondence Address: BIRCH STEWART KOLASCH & BIRCH, PO BOX 747, FALLS CHURCH, VA, 22040-0747, US

(73) Assignee: NICHIHA CORPORATION, Nagoya-Shi (JP)

(21) Appl. No.: 11/972,497

(22) Filed: Jan. 10, 2008

(30) Foreign Application Priority Data
Jan. 12, 2007 (JP) 2007-004212

(51) Int. Cl. B32B 13/02; B28B 3/00

(52) U.S. Cl. 428/294.7; 249/13

(57) ABSTRACT

The present invention provides a bearing wall with a low specific gravity of as low as 1.0 or less and a wall-magnification of 2.5 or more, which is excellent in strength, fire-safety, workability, dimensional stability, freezing resistance, water resistance and earthquake resistance, and a method for manufacturing the board. The board is produced by a method that contains the steps of: preparing a slurry by dispersing a cement-based hydraulic material, a fiber reinforcing material and a lightweight aggregate into water, adding a saturated carboxylic acid to the slurry, and then forming the slurry into a sheet, dehydrating the sheet, pressing the sheet and curing the sheet. The fiber reinforcing material includes a refined fiber with a freeness of 650 ml or less and an unrefined fiber and the saturated carboxylic acid is preferably a stearic acid-based carboxylic acid or a succinic acid-based carboxylic acid.

### FIELD OF THE INVENTION

The present invention relates to a board for a bearing wall that is excellent in strength, fire-safety, workability, dimensional stability, freezing resistance and/or water resistance, and a method of producing the same.

### BACKGROUND OF THE INVENTION

A building can be deformed over lengthy periods of time, in addition to receiving forces caused by earthquakes and/or wind. Therefore, in general bracing and/or laths have been used as building materials for a structural wall (bearing wall) to resist forces caused by earthquakes, wind and/or deformation taking place over lengthy periods of time. Recently, however, a board for a bearing wall (a bearing wall board) has been used in place of a bracing or laths. The bearing wall board is disposed so as to close an opening formed by a skeleton framing made of a post and a horizontal member such as a beam and a base. In this configuration, the bearing wall board is secured with screws to the skeleton framing along the periphery of the board, which enhances the earthquake resistance of the building.

After experiencing the “Hanshin-Awaji earthquake disaster” in 1995, the importance of earthquake resistance and fire-retardant property has been reacknowledged, this is in turn increasing the demand for bearing wall boards. More recently, in Japan the number of buildings of the three-story wooden house variety have been rapidly increasing in metropolitan areas, and a bearing wall board is used as a wall of such houses as a means for increasing the earthquake resistance of the houses.

The strength of a wall using a bearing wall board depends on the type of bearing wall board used, the thickness of the board, and the way of securing the board. The strength is represented by an index of “wall-magnification”. A bearing wall board for general use has its own wall-magnification. The larger the wall magnification is, the stronger the board is.

As a bearing wall board, a variety of boards are available, such as, structural plywood, particleboard, hardboard, flexible board, asbestos perlite board, asbestos silicate calcium board, hardwood block cement board, pulp cement board and plaster board. A structural plywood made of laminated wood is in widespread use and is excellent in strength, as the wall magnification property associated therewith is identified as 1.5-2.5. However it is burnable, i.e., poor in fire-safety, and it is poor in durability. Also it is poor in both moisture permeability and air permeability, which causes a lot of dew/water condensation at inner side of the bearing wall, i.e., on the heat insulating layer. Such dew/water condensation over lengthy periods of time leads to corrosion of the board.

Since the raw material of the structural plywood is a wood, its use can contribute to environmental destruction through deforestation. The use of plywood may also cause problems to the dwelling environment, since adhesive agents used for manufacturing the plywood can cause eye pain and/or headaches to residents. Particleboard and hardboard are also burnable and poor in fire-safety, durability and moisture and air permeability. Flexible board, asbestos perlite board and asbestos silicate calcium board also have a safety problem since they contain asbestos. Plaster board is excellent in fire-safety and economical efficiency. However, plaster board is also poor in strength and brittle, which means poor constructability (e.g., in nailing and nail-gripping properties), and poor in moisture resistance and water resistance. The wall-magnification thereof is as small as 1.0-1.5.

In view of above factors, the demand for cement-based boards such as hard-type wood chip cement board, pulp cement board and the like has been increasing because they are good in strength, freezing resistance, moisture resistance, and water resistance, in addition to being excellence in fire-safety, corrosion resistance and economical efficiency. A wall magnification of general cement-based board is between 1.5 and 2.5, as set by regulations. However cement-based board is heavy since the specific gravity thereof is 1.0 or more. Therefore two workers are usually needed to handle the board, which provides a slight inconvenience in working. Also because of hardness of the board, unexpected cracks can occur when the board is nailed or screwed to be fixed, which may cause the board to fall. Thus it is necessary to make holes in the board before using nails or screws. However, many holes have to be prepared since its use in a bearing wall requires many nailed points. This can become troublesome work and thus makes the workability of cement-based board worse. Since an inorganic board includes a cement and a fiber reinforcing material as raw materials, dimensional changes may be caused by calcium hydrate and/or the fiber reinforcing material in the board. Also an inorganic board has a lot of pores in the inside thereof. If there is water in the pores, carbon dioxide in the air is dissolves into water to form carbonic acid which reacts with calcium hydrate in the board to cause dimensional shrinkage (so-called carbonation shrinkage). Further improvements in performance, such as wall-magnification, freezing resistance and water resistance have been desired.

As one improvement, JP2000-336833 discloses a bearing wall board produced by extrusion molding, by extruding a kneaded mixture of a latent hydraulicity material, a kneading regulator, a hardening stimulating agent and water without containing asbestos at all.

JP2003-095727 discloses an inorganic bearing wall board and method for manufacturing the same where the inorganic bearing wall board is manufactured by wet-molding of a blended material of a cement, a reinforcing fiber and a calcium silicate hydrate, wherein a slurry of calcium silicate hydrate is used as the calcium silicate hydrate. The slurry is produced by carrying out a hydrothermal reaction using a calcic raw material and a siliceous raw material in the presence of barium chloride and/or aluminum chloride. The inorganic bearing wall board has a bulk density of 0.5-1.2, bending strength of 10-30N/mm² and wall-magnification of 2.5 or more.

However, the bearing wall board disclosed in JP2000-336833 is still high in specific gravity, i.e., insufficient in improving workability. Also no improvement has been made in dimensional change, freezing resistance and water resistance.

Also the bearing wall board disclosed in JP2003-095727 does not show an improvement in dimensional change, freezing resistance and water resistance.

### SUMMARY OF THE INVENTION

An object of the present invention is to solve the above mentioned problems and provide a bearing wall with a low specific gravity, as low as 1.0 or less, and a wall-magnification of 2.5 or more, which is excellent in strength, fire-safety, workability, dimensional stability, freezing resistance, water resistance and earthquake resistance, and a method for manufacturing a bearing wall board used to build/make such bearing walls. The present invention is described below.

The present invention provides a bearing wall board comprising; a cement-based hydraulic material, a fiber reinforcing material, a lightweight aggregate, and a saturated carboxylic acid. As a cement-based hydraulic material, for example, Portland cement, mixed cement, eco-cement, low heat cement, and alumina cement can be used. As a fiber reinforcing material, wood fiber such as waste paper, wood pulp, wood fiber bundle, wood fiber, wood chip, wood wool, wood flour; inorganic fiber such as glass fiber, carbon fiber; and organic fiber such as polyamide fiber, wollastonite, polypropylene fiber, polyvinyl alcohol fiber, polyester fiber and polyethylene fiber can be used. It is preferable to use a wood pulp and more preferable to use a softwood unbleached kraft pulp (NUKP), a softwood bleached kraft pulp (NBKP), a hardwood unbleached kraft pulp (LUKP) and a hardwood bleached kraft pulp (LBKP). It is most preferred to use a softwood pulp such as (NUKP) or (NBKP). As a lightweight aggregate, perlite, silica fume and the like can be used. As a saturated carboxylic acid, lauric acid-based carboxylic acid, caproic acid-based carboxylic acid, propionic acid-based carboxylic acid, stearic acid-based carboxylic acid, succinic acid-based carboxylic acid and the like can be used.

The present invention also provides a bearing wall board as described above, wherein the cement-based hydraulic material is contained in an amount of 20 weight % or more and 60 weight % or less, based on the total solid content; the fiber reinforcing material is contained in an amount of 6 weight % or more and 20 weight % or less, based on the total solid content; the lightweight aggregate is contained in an amount of 3 weight % or more and 18 weight % or less, based on the total solid content; and the saturated carboxylic acid is contained in an amount of 0.1 weight % or more and 2.0 weight % or less, based on the total solid content. A bearing wall board containing a cement-based hydraulic material in an amount of 20 weight % or more and 60 weight % or less, based on the total solid content, is excellent in strength. If the contained cement-based hydraulic material is less than 20 weight %, based on the total solid content, the board possesses a lack of strength. If the contained cement-based hydraulic material exceeds 60 weight %, based on the total solid content, it becomes easily to cause brittle fractures in the board, which makes it difficult to improve wall-magnification and to solve the problem of unexpected cracks that is caused when the board is being fixed (e.g., being nailed or screwed). A bearing wall board containing a fiber reinforcing material in an amount of 6 weight % or more and 20 weight % or less, based on the total solid content, is excellent in strength and deflection property. If the contained fiber reinforcing material is less than 6 weight %, based on the total solid content, the specific gravity of the board becomes high and deflection of the board becomes much less, which leads to poor constructability. If the contained fiber reinforcing material exceeds 20 weight %, based on the total solid content, the percentage of cement-based hydraulic material becomes low and an inhibiting-hardening ingredient that is eluted from the fiber reinforcing material increases, which lowers the strength of the bearing wall board. Also the fire-safety property becomes low since the percentage of organic ingredient increases. A bearing wall board containing a lightweight aggregate in an amount of 3 weight % or more and 18 weight % or less, based on the total solid content, is excellent in workability because the specific gravity is lowered. If the amount of the contained lightweight aggregate is less than 3 weight %, based on the total solid content, the specific gravity becomes high and constructability (e.g., putting in a nail becomes poor). If the amount of the contained lightweight aggregate exceeds 18 weight %, based on the total solid content, the percentage of cement-based hydraulic material and fiber reinforcing material becomes low, which lowers the strength of the bearing wall board. Further, a bearing wall board becomes excellent in water absorption resistance, dimensional stability and frost damage resistance when it contains a saturated carboxylic acid in an amount of 0.1 weight % or more and 2.0 weight % or less, based on the total solid content. If the amount of contained saturated carboxylic acid is less than 0.1 weight %, based on the total solid content, the board becomes insufficient in water absorption resistance, dimensional stability and frost damage resistance. If the contained amount of saturated carboxylic acid exceeds 2.0 weight %, based on the total solid content, hardening of the cement-based hydraulic material is prevented, which lowers the strength of the bearing wall board. In consideration of cost performance, it is preferable to use a saturated carboxylic acid in an amount of 0.3 weight % to 1.0 weight %, based on the total solid content.

The present invention also provides a bearing wall board as described above, wherein the fiber reinforcing material comprises a refined fiber with freeness of 650 ml or less and an unrefined fiber. As for refining, there is no particular limitation. However, it is preferable to obtain the refined fiber with a freeness of 650 ml or less by using a refiner such as a disk refiner since through the operation fibrils located at the inner part of fiber reinforcing material come out to the surface and this configuration is suitable for adsorbing and capturing substances. Freeness is a value defined by the Canadian Standard Measuring method (Canadian Standard Freeness). Unrefined fiber is a fiber which has not been refined by a refiner such as a disk refiner. When using a combination of a refined fiber reinforcing material with freeness of 650 ml or less and an unrefined fiber reinforcing material, the refined fiber captures raw materials such as cement-based hydraulic material and saturated carboxylic acid and further the unrefined fiber forms a network between fibers. As a result, raw materials such as a cement-based hydraulic material, a saturated carboxylic acid and the like are prevented from being drained with the water that is removed during a dehydration process and the dehydrating sheet is prevented from clogging. Thus, slurry dehydration processes are improved, which leads to better production efficiency. Since the strength of the ceramic-based building materials being produced is excellent in both strength and deflection property, the wall-magnification thereof reaches 2.5 or more. Further unrefined fiber is less in energy cost and better in productivity, which leads to a cost reduction and an improvement in production efficiency. In consideration of cost performance, it is preferable to use a refined fiber of 1-6 weight % and an unrefined fiber of 5-14 weight % in combination, based on the total solid content.

The present invention also provides a bearing wall board as described above, wherein the saturated carboxylic acid is a stearic acid-based carboxylic acid or a succinic acid-based carboxylic acid. As a saturated carboxylic acid, although many types such as lauric acid-based, caproic acid-based, propionic acid-based carboxylic acid can be used, it is particularly preferred to use a stearic acid-based or succinic acid-based carboxylic acid because of the good/high effects that are associated therewith.

The present invention also provides a method for producing a bearing wall board comprising steps of: preparing a slurry by dispersing a cement-based hydraulic material, a refined fiber with a freeness of 650 ml or less, an unrefined fiber and a lightweight aggregate into water, adding a saturated carboxylic acid (e.g., a stearic acid-based carboxylic acid or a succinic acid-based carboxylic acid) to the slurry, and then forming the slurry into a sheet, dehydrating the sheet, pressing the sheet and curing the sheet. The method; which comprises steps of preparing a slurry by dispersing a cement-based hydraulic material, a refined fiber with freeness of 650 ml or less, an unrefined fiber and a lightweight aggregate into water, and adding a saturated carboxylic acid (e.g., a stearic acid-based carboxylic acid or a succinic acid-based carboxylic acid) to the slurry, provides the following results. Production trouble such as surfacing of the water-repellent agent and/or foaming can be prevented, saturated carboxylic acid is dispersed uniformly to cover the calcium hydrate and/or is captured by the fiber reinforcing material. In addition, saturated carboxylic acid and the calcium hydrate coated with saturated carboxylic acid are also captured by the fiber reinforcing material. Consequently, a saturated carboxylic acid is prevented from being drained with the water that is removed during the dehydration process, and a saturated carboxylic acid can remain in the form of a coating on the calcium hydrate and the fiber reinforcing material. Also the bearing wall board to be produced is excellent in both strength and deflection property. As a saturated carboxylic acid, although many types such as lauric acid-based, caproic acid-based and propionic acid-based carboxylic acid can be used, it is particularly preferred to use a stearic acid-based or succinic acid-based carboxylic acid because of the good/high effects that are achieved with only a small amount thereof.

The present invention also provides a method for producing a bearing wall board comprising steps of: preparing a slurry by dispersing a refined fiber with freeness of 650 ml or less and an unrefined fiber into water, adding a saturated carboxylic acid (e.g., a stearic acid-based carboxylic acid or a succinic acid-based carboxylic acid) to the slurry, agitating the slurry, and then dispersing a cement-based hydraulic material and a lightweight aggregate into the slurry to form a complete slurry, and forming the complete slurry into a sheet, dehydrating the sheet, pressing the sheet and curing the sheet. The method, which comprises steps of preparing a slurry by dispersing a refined fiber with freeness of 650 ml or less and an unrefined fiber, and adding a saturated carboxylic acid (e.g., a stearic acid-based carboxylic acid or a succinic acid-based carboxylic acid) to the slurry, provides the following results. Production trouble such as surfacing of the water-repellent agent and/or foaming can be prevented, saturated carboxylic acid is dispersed uniformly to be captured by the fiber reinforcing material. Consequently, a saturated carboxylic acid is prevented from being drained with the water that is removed during the dehydration process, and a saturated carboxylic acid can remain in the form of coating on the calcium hydrate and the fiber reinforcing material. Also, the bearing wall board to be produced is excellent in both strength and deflection property. As a saturated carboxylic acid, although many types such as lauric acid-based, caproic acid-based and propionic acid-based carboxylic acid can be used, it is particularly preferred to use a stearic acid-based or succinic acid-based carboxylic acid because of the good/high effects that are achieved with only a small amount thereof.

A bearing wall board of the present invention has an improved workability since the board is excellent in strength, bending and constructability (e.g., in putting in a nail) in addition to a low specific gravity of 1.0 or less, which are obtained without deteriorating the fire-safety property thereof. The board has a wall-magnification of 2.5 or more, i.e., it possesses high earthquake resistance.

Also in the board of this invention, calcium hydrate and fiber reinforcing material are coated with saturated carboxylic acid, which serves to protect the board from water absorption, dimensional change and carbonation shrinkage, and which secures water resistance, dimensional stability and freezing resistance for the long term.

Further, as the saturated carboxylic acid is captured by a refined fiber reinforcing material in the present invention, surfacing of the water-repellent agent and/or foaming can be prevented, and yet a small amount of carboxylic acid can unexpectedly work well.

This invention can be broadly applied to other methods in addition to the sheet-making method, for example, an extrusion molding method or a casting method in which a slurry is molded in a mold.

### DETAILED DESCRIPTION OF THE INVENTION

Preferred embodiments of the bearing wall board of the present invention and the method for producing the same are described below.

First, a raw material is prepared by blending the following materials and dispersing them into water: a cement-based hydraulic material (such as Portland cement) ranging from 20 weight % to 60 weight %, a wood pulp as a refined fiber reinforcing material with freeness of 650 ml or less of 4 weight %, a wood pulp as unrefined fiber reinforcing material and a waste paper of 14 weight %, and a perlite as lightweight aggregate of 10 weight %, and further when needed, silica sand, silica, Shirasu balloon, vermiculite, blast-furnace slag, an expansive shale, an expansive clay, calcined diatomaceous earth, gypsum powder, mica, fly ash, coal cinder, and/or sludge incinerated ash.

The reason why a refined wood pulp with a freeness of 650 ml or less is used is described below. A refined wood pulp with a freeness of 650 ml or less can be easily and uniformly dispersed into the slurry. In addition, the configuration of such a refined wood pulp is suitable for adsorbing and capturing substances. A fiber reinforcing material such as pulp is a bundle made of a number of fibrils (micro fibers). The fibrils are normally tied in a bundle by hydrogen bonding or intermolecular forces and when refined under wet conditions, the fibrils are torn along an air groove between fibrils to make the fiber reinforcing material finer so as to be uniformly dispersed into the slurry. The friction caused by refining makes the fibrils located at the inner part of the bundles come out to the surface of the bundle, which causes the surface of the fiber reinforcing material to be raised and finely split. Particularly under wet conditions, fibrils come out like whiskers, which increases their specific surface area and makes the configuration suitable for adsorbing and capturing substances, that is, suitable for holding a raw material such as a cement-based hydraulic material, a saturated carboxylic acid and the like. As a result, raw materials such as a cement-based hydraulic material, a saturated carboxylic acid and the like are prevented from being drained with the water that is removed during the dehydration process. A refined wood pulp with a freeness of 500 ml or less is more preferable since the configuration becomes more capable of adsorbing and capturing substances. Also, a refined wood pulp with a freeness of 650 ml or less provides other advantages such as the strength of the fiber is increased, which increases the strength of the ceramic-based building material to be produced. The reason why unrefined wood pulp and waste paper are used is that a network between fibers can be easily formed, which improves the bending property of the ceramic-based building material and leads to better workability in construction. Further, the use of unrefined wooden pulp and waste paper results in less energy cost and better productivity than refined wooden pulp. In the use of a combination of a refined wooden pulp and an unrefined wooden pulp, raw materials such as cement-based hydraulic materials and saturated carboxylic acid are captured by the refined wooden pulp and also captured by a network formed by the unrefined wooden pulp. As a result, raw materials such as a cement-based hydraulic material, a saturated carboxylic acid and the like are prevented from being drained with the water that is removed during the dehydration process and the dehydrating sheet is prevented from clogging. Thus, the slurry dehydration process is improved, which leads to better production efficiency. Since the strength of the ceramic-based building materials to be produced is excellent in both strength and bending property, the wall-magnification reaches 2.5 or more. Further, unrefined wooden pulp is less in energy cost and better in productivity than refined wooden pulp, which leads to a cost reduction and an improvement in production efficiency.

Then, a carboxylic acid-based emulsion solution (e.g., a stearic acid-based or a succinic acid-based emulsion solution) is added to the above slurry so that a solid content of the emulsion accounts for 1 weight % or less, based on the total solid content of the slurry. After agitating, the slurry is cast onto a dehydrated felt to form a wet sheet. After the wet sheet has been dehydrated, the wet sheet is piled up using a making roll so as to form a laminated mat with 6-15 layers. The laminated mat undergoes a primary cure wherein it is pressed at pressures of 1.5 MPa-10 MPa, then cured at 60-90° C. for 5-10 hours. When needed, steam curing or curing in an autoclave is further carried out. Steam curing is carried out at 50-80° C. for 15-24 hours in a steam-filled atmosphere, whereas autoclave curing is carried out at 120-200° C. for 7-15 hours. After curing, the mat is dried and if needed, coatings are applied to a front surface, a rear surface and a butt end surface, to form the product.

The reason why a carboxylic acid-based emulsion solution (e.g., a stearic acid-based or a succinic acid-based emulsion solution) is used is because of its water-repellent effect, good dispersion into water and capability of being coated on a calcium hydrate and a refined fiber reinforcing material. The carboxylic acid-based emulsion solution (e.g., a stearic acid-based or a succinic acid-based emulsion solution) is uniformly dispersed in the slurry and coated on the calcium hydrate of cement-based hydraulic material and on the refined fiber reinforcing material, which prevents the calcium hydrate of the inorganic board from absorbing water and being carbonated, and prevents the refined fiber reinforcing material from absorbing water. Therefore, in the inorganic board, water absorption resistance, dimensional stability and frost damage resistance can be improved. Further the calcium hydrate coated therewith is captured by the refined fiber reinforcing material, consequently the calcium hydrate coated therewith is prevented from being drained with the water, which is removed during the dehydration process. This makes it possible to secure water absorption resistance, dimensional stability and frost damage resistance of the inorganic board for a long time.

### EXAMPLES

Various inorganic boards were produced according to the following conditions as shown in Examples 1-8 and Comparison Examples 1-8.

### Example 1

A raw material containing the following materials is dispersed into water to make a raw material slurry; i.e., 30 weight % of Portland cement, 4 weight % of refined wood pulp with a freeness of 500 ml, 6 weight % of an unrefined wood pulp with a freeness of 780 ml, 8 weight % of an unrefined waste paper, 10 weight % of perlite and 42 weight % of a blast furnace slag and fly ash, wherein the weight % is based on the weight of the raw material. A stearic acid emulsion solution is added to the above slurry so that the stearic acid accounts for 0.5 weight %, based on the total solid content of the slurry. After agitating, the slurry is cast onto a dehydrating felt to form a wet sheet. After dehydration, the wet sheet is piled up using a making roll so as to form a laminated mat with 6 layers. The laminated mat is pressed by high-pressing of 2.5 MPa for 7 seconds, then cured by steam at 70° C. and dried to form a bearing wall board.

### Example 2

A stearic acid emulsion solution is added to the same raw material slurry as in Example 1 so that the stearic acid accounts for 1.0 weight %, based on the total solid content of the slurry. After agitating, the same method of forming a wet sheet, dehydrating, pressing and hardening/curing as was used in Example 1 were carried out for producing a bearing wall board.

### Example 3

A stearic acid emulsion solution is added to the same raw material slurry as in Example 1 so that the stearic acid accounts for 2.0 weight %, based on the total solid content of the slurry. After agitating, the same method of forming a wet sheet, dehydrating, pressing, and hardening/curing as were used in Example 1 were carried out for producing a bearing wall board.

### Example 4

A succinic acid emulsion solution is added to the same raw material slurry as in Example 1 so that the succinic acid accounts for 0.5 weight %, based on the total solid content of the slurry. After agitating, the same method of forming a wet sheet, dehydrating, pressing and hardening/curing as were used in Example 1 were carried out for producing a bearing wall board.

### Example 5

A succinic acid emulsion solution is added to the same raw material slurry as in Example 1 so that the succinic acid accounts for 1.0 weight %, based on the total solid content of the slurry. After agitating, the same method of forming a wet sheet, dehydrating, pressing and hardening/curing as were used in Example 1 were carried out for producing a bearing wall board.

### Example 6

A succinic acid emulsion solution is added to the same raw material slurry as in Example 1, so that the succinic acid accounts for 2.0 weight %, based on the total solid content of the slurry. After agitating, the same method of forming a wet sheet, dehydrating, pressing and hardening/curing as those were in Example 1 were carried out for producing a bearing wall board.

### Example 7

The following materials are dispersed into water to make a slurry; i.e., a refined wood pulp with a freeness of 500 ml, an unrefined wood pulp with a freeness of 780 ml and a waste paper. Then a stearic acid emulsion solution is added to the slurry, and after agitating, Portland cement, perlite, a blast furnace slag and fly ash are added to the slurry with agitation and uniformly dispersed. Then the same method of forming a wet sheet, dehydrating, pressing and hardening/curing as was used in Example 1 were carried out for producing a bearing wall board. The raw material composition of the slurry is the same as that of Example 3. The only the difference from Example 3 is the way of adding the stearic acid emulsion solution.

### Example 8

The following materials are dispersed into water to make a slurry; i.e., a refined wood pulp with a freeness of 500 ml, an unrefined wood pulp with a freeness of 780 ml and a waste paper. A succinic acid emulsion solution is added to the slurry. After agitating, Portland cement, perlite, a blast furnace slag and fly ash are added to the slurry with agitation and uniformly dispersed. Then the same method of forming a wet sheet, dehydrating, pressing and hardening/curing as was used in Example 1 were carried out for producing a bearing wall board. The raw material composition of the slurry is the same as that of Example 6. The only the difference from Example 6 is the way of adding the succinic acid emulsion solution.

### Comparison Example 1

Example 1 was repeated except that saturated carboxylic acid emulsion solution was not added to the same raw material composition slurry as in Example 1. After agitating, the same method of forming a wet sheet, dehydrating, pressing and hardening/curing as that in Example 1 was carried out for producing a bearing wall board.

### Comparison Example 2

A stearic acid emulsion solution is added to the same raw material composition slurry as in Example 1 so that the stearic acid accounts for 3.0 weight %, based on the total solid content of the slurry. After agitating, the same method of forming a wet sheet, dehydrating, pressing and hardening/curing as that in Example 1 was carried out for producing a bearing wall board.

### Comparison Example 3

A succinic acid emulsion solution is added to the same raw material composition slurry as in Example 1, so that the succinic acid accounts for 3.0 weight %, based on the total solid content of the slurry. After agitating, the same method of forming a wet sheet, dehydrating, pressing and hardening/curing as that in Example 1 was carried out for producing a bearing wall board.

### Comparison Example 4

A paraffin solution is added to the same raw material composition slurry as in Example 1 so that the paraffin accounts for 1.0 weight %, based on the total solid content of the slurry. After agitating, the same method of forming a wet sheet, dehydrating, pressing and hardening/curing as that in Example 1 was carried out for producing a bearing wall board.

### Comparison Example 5

Example 1 was repeated except that the refined wood pulp with a freeness of 500 ml was not used and the amount of an unrefined wood pulp with a freeness of 780 ml is increased from 6 weight % to 10 weight %.

### Comparison Example 6

Example 4 was repeated except that a refined wood pulp with a freeness of 500 ml was not used and the amount of an unrefined wood pulp with a freeness of 780 ml is increased to 10 weight %.

### Comparison Example 7

Example 1 was repeated except that the amount of a refined wood pulp with a freeness of 500 ml was increased to 7 weight %.

### Comparison Example 8

Example 4 was repeated except that the amount of a refined wood pulp with a freeness of 500 ml was increased to 7 weight %.

With respect to each inorganic board of Examples 1-8 and Comparison Examples 1-7, the following items were measured; thickness, specific gravity, moisture content, bending strength, Young's modulus in flexure, maximum amount of deflection, amount of surface water absorption, elongation percentage by water absorption, shrinkage percentage by releasing moisture, carbonation shrinkage percentage, freezing-thawing resistance, wall-magnification, constructability in putting in a nail and fire-safety. The results are shown in Table 1. Bending strength, Young's modulus in flexure and maximum amount of deflection were measured using a test piece of 500 mm×400 mm pursuant to JIS A 1408. The amount of surface water absorption was measured using a frame method and is represented by the weight change after 24 hours of the bearing wall board defined by the following Formula 1. Elongation percentage by water absorption is defined as the percentage of elongation of the board in which water is absorbed after being exposed to humid conditions at 60° C. for 3 days and then being soaked in water for 8 days. Shrinkage percentage by releasing moisture is defined as the percentage of dimensional shrinkage of the board after releasing moisture by having humidity conditioning at 20° C. and 60% RH for 10 days and then being dried at 80° C. for 10 days. Carbonation shrinkage percentage is defined as the percentage of dimensional shrinkage of the board after being exposed to 5% CO₂ for 7 days and then being dried at 120° C. for 10 days. Freezing-thawing resistance is defined as percentage of thickness swelling of an end portion (in the longitudinal direction) of a test piece board with a size of 10 cm×25 cm (wherein the end portion of the test piece board is soaked in water in a container), after having 30 cycles, where a cycle is defined as a pair of processes of 12 hours freezing of the board and 12 hours thawing of the board at room temperature. Wall-magnification is measured pursuant to the inplane shear test of JIS A 1414. Constructability of putting in a nail is evaluated as follows. After nailing the board for measuring wall-magnification, if a crack or a breakage is not recognized by visual observation, the evaluation is represented by the symbol “∘”, if a crack or a breakage is recognized, the evaluation is represented by the symbol “X”. Fire-safety is evaluated as follows. If the total heat release value for 10 minutes of heating is 8 MJ/m² or less and maximum heat releasing rate does not exceed 200 KW/m at least for 10 seconds in a row and there is no crack or hole penetrating to the other side, evaluation of fire-safety is represented by the symbol “∘”, in the case of all the rest, evaluation is represented by the symbol “X”.

TABLE 1

| | | | Examples | | | | | | | |
|---|---|---|---|---|---|---|---|---|---|---|
| | | Unit | 1 | 2 | 3 | 4 | 5 | 6 | 7 | 8 |
| Composition | Portland cement | % | 30 | | | | | | | |
| | Refined fiber | % | 4 | | | | | | | |
| | reinforcing material | | | | | | | | | |
| | unrefined fiber | % | 14 | | | | | | | |
| | reinforcing material | | | | | | | | | |
| | Perlite | % | 10 | | | | | | | |
| | Blast furnace slag | % | 42 | | | | | | | |
| | and fly ash | | | | | | | | | |
| Amount of | Stearic acid | % | 0.5 | 1.0 | 2.0 | — | | | 2.0 | — |
| added | Succinic acid | % | — | | | 0.5 | 1.0 | 2.0 | — | 2.0 |
| saturated | To what added | | Slurry formed by dispersing cement- | | | | | | Slurry formed | |
| carboxylic | | | based hydraulic material, fiber | | | | | | by dispersing | |
| acid | | | reinforcing material and lightweight | | | | | | fiber reinforcing | |
| (weight % | | | aggregate into water | | | | | | material into | |
| base on the | | | | | | | | | water | |
| total solid | | | | | | | | | | |
| content) | | | | | | | | | | |
| Properties of | Thickness | mm | 11.9 | 12.0 | 11.8 | 11.9 | 11.7 | 12.1 | 11.9 | 11.8 |
| the board | Specific gravity | | 0.94 | 0.95 | 0.92 | 0.93 | 0.94 | 0.88 | 0.93 | 0.91 |
| | Moisture content | % | 8.7 | 9.4 | 8.1 | 8.4 | 8.6 | 7.2 | 8.6 | 8.5 |
| | Bending strength | N/mm² | 13.8 | 13.6 | 13.5 | 13.4 | 13.1 | 12.2 | 13.5 | 13.0 |
| | Young's modulus in | k N/mm² | 3.7 | 3.8 | 3.4 | 3.4 | 3.5 | 2.7 | 35 | 3.2 |
| | flexure | | | | | | | | | |
| | Maximum amount of | mm | 12.6 | 11.9 | 12.4 | 13.1 | 12.7 | 18.4 | 12.1 | 14.1 |
| | deflection | | | | | | | | | |
| | Amount of surface | g/m² | 2200 | 1950 | 1230 | 1820 | 1420 | 1140 | 1190 | 1150 |
| | water absorption | | | | | | | | | |
| | Elongation percentage | % | 0.11 | 0.09 | 0.09 | 0.09 | 0.07 | 0.07 | 0.09 | 0.07 |
| | by water absorption | | | | | | | | | |
| | Shrinkage percentage | % | 0.26 | 0.27 | 0.26 | 0.24 | 0.26 | 0.27 | 0.26 | 0.26 |
| | by releasing moisture | | | | | | | | | |
| | Carbonation shrinkage | % | 0.09 | 0.07 | 0.04 | 0.09 | 0.06 | 0.07 | 0.04 | 0.07 |
| | percentage | | | | | | | | | |
| | Freezing-thawing | % | 3.20 | 2.80 | 2.10 | 4.80 | 3.40 | 3.10 | 2.20 | 3.10 |
| | resistance | | | | | | | | | |
| | Wall-magnification | | 3.4 | 3.3 | 3.4 | 3.2 | 3.2 | 3.0 | 3.3 | 2.9 |
| | Constructability in | | ◯ | ◯ | ◯ | ◯ | ◯ | ◯ | ◯ | ◯ |
| | putting in a nail | | | | | | | | | |
| | Fire-safety | | ◯ | ◯ | ◯ | ◯ | ◯ | ◯ | ◯ | ◯ |
| | | | Comparison Examples | | | | | | | |
| | | Unit | 1 | 2 | 3 | 4 | 5 | 6 | 7 | 8 |
| Composition | Portland cement | % | 30 | | | | | | | |
| | Refined fiber | % | 4 | | | | 0 | | 7 | |
| | reinforcing material | | | | | | | | | |
| | Unrefined fiber | % | 14 | | | | 18 | | 14 | |
| | reinforcing material | | | | | | | | | |
| | Perlite | % | 10 | | | | | | | |
| | Blast furnace slag | % | 42 | | | | | | | |
| | fly ash | | | | | | | | | |
| Amount of | Stearic acid | % | — | 3.0 | — | — | 0.5 | — | 0.5 | — |
| added | Succinic acid | % | — | — | 3.0 | — | — | 0.5 | — | 0.5 |
| saturated | Paraffin | % | — | — | — | 1.0 | — | — | — | — |
| carboxylic | To what added | | — | Slurry formed by dispersing cement-based | | | | | | |
| acid | | | | hydraulic material, fiber reinforcing | | | | | | |
| (weight % | | | | material and lightweight aggregate into | | | | | | |
| base on the | | | | water | | | | | | |
| total solid | | | | | | | | | | |
| content) | | | | | | | | | | |
| Properties of | Thickness | mm | 11.8 | 12.1 | 12.2 | 11.8 | 11.8 | 11.8 | 12.4 | 12.6 |
| the board | Specific gravity | | 0.95 | 0.90 | 0.84 | 0.96 | 0.92 | 0.93 | 0.86 | 0.84 |
| | Moisture content | % | 9.1 | 9.0 | 6.3 | 9.2 | 8.2 | 8.7 | 10.3 | 9.7 |
| | Bending strength | N/mm² | 13.5 | 10.9 | 9.8 | 8.6 | 12.5 | 12.9 | 9.7 | 8.9 |
| | Young's modulus in | k N/mm² | 3.9 | 2.1 | 1.9 | 1.8 | 3.1 | 2.9 | 1.7 | 1.8 |
| | flexure | | | | | | | | | |
| | Maximum amount of | mm | 11.8 | 22.1 | 25.3 | 16.8 | 12.4 | 12.7 | 16.4 | 18.7 |
| | deflection | | | | | | | | | |
| | Amount of surface | g/m² | 4500 | 960 | 840 | 1210 | 3120 | 3040 | 6320 | 5840 |
| | water absorption | | | | | | | | | |
| | Elongation percentage | % | 0.16 | 0.12 | 0.18 | 0.29 | 0.14 | 0.15 | 0.31 | 0.33 |
| | by water absorption | | | | | | | | | |
| | Shrinkage percentage | % | 0.25 | 0.36 | 0.45 | 0.32 | 0.31 | 0.26 | 0.44 | 0.50 |
| | by releasing moisture | | | | | | | | | |
| | Carbonation shrinkage | % | 0.22 | 0.03 | 0.05 | 0.33 | 0.14 | 0.11 | 0.32 | 0.29 |
| | percentage | | | | | | | | | |
| | Freezing-thawing | % | 12.0 | 25.8 | 28.9 | 27.4 | 11.0 | 18.2 | 41.5 | 38.1 |
| | resistance | | 0 | 0 | 0 | 0 | 0 | 0 | 0 | 0 |
| | Wall-magnification | | 3.3 | 2.5 | 2.2 | 1.8 | 2.8 | 2.6 | 2.4 | 2.3 |
| | Constructability in | | ◯ | ◯ | ◯ | ◯ | ◯ | ◯ | ◯ | ◯ |
| | putting in a nail | | | | | | | | | |
| | Fire-safety | | ◯ | ◯ | ◯ | ◯ | ◯ | ◯ | X | X |

Formula I:
$\frac{\{ weight ( g ) after measuring ( after 24 hours ) - initial weight ( g ) \}}{0.2 \times 0.2 ( area in the frame \text{:} {m}^{2} )}$

### Regarding Example 1

In producing the bearing wall board of Example 1, 4 weight % of a refined wood pulp with a freeness of 500 ml, 6 weight % of an unrefined wood pulp with a freeness of 780 ml and 8 weight % of an unrefined waste paper and a stearic acid emulsion solution were used, wherein the stearic acid emulsion solution was added to the slurry so that the stearic acid accounted for 0.5 weight %, based on the total solid content of the slurry, which, as shown in Table 1, provided a bearing wall board with no problem in the properties such as specific gravity, moisture content, bending strength, Young's modulus in flexure, maximum amount of deflection, and shrinkage percentage by releasing moisture, constructability in putting in a nail and fire-safety; and was excellent in the properties such as amount of surface water absorption, elongation percentage by water absorption, carbonation shrinkage percentage, freezing-thawing resistance and wall-magnification. Also, almost no stearic acid was found in the water which drained off during dehydration.

### Regarding Example 2

In producing the bearing wall board of Example 2, 4 weight % of a refined wood pulp with a freeness of 500 ml, 6 weight % of an unrefined wood pulp with a freeness of 780 ml and 8 weight % of an unrefined waste paper and a stearic acid emulsion solution were used, wherein the stearic acid emulsion solution was added to the slurry so that the stearic acid accounted for 1.0 weight %, based on the total solid content of the slurry, which, as shown in Table 1, provided a bearing wall board with no problem in the properties such as specific gravity, moisture content, bending strength, Young's modulus in flexure, maximum amount of deflection, and shrinkage percentage by releasing moisture, constructability in putting in a nail and fire-safety; and was excellent in the properties such as amount of surface water absorption, elongation percentage by water absorption, carbonation shrinkage percentage, freezing-thawing resistance and wall-magnification. Also, almost no stearic acid was found in the water which drained off during dehydration.

### Regarding Example 3

In producing the bearing wall board of Example 3, 4 weight % of a refined wood pulp with a freeness of 500 ml, 6 weight % of an unrefined wood pulp with a freeness of 780 ml and 8 weight % of an unrefined waste paper and a stearic acid emulsion solution were used, wherein the stearic acid emulsion solution was added to the slurry so that the stearic acid accounted for 2.0 weight %, based on the total solid content of the slurry, which, as shown in Table 1, provided a bearing wall board with no problem in the properties such as specific gravity, moisture content, bending strength, Young's modulus in flexure, maximum amount of deflection, and shrinkage percentage by releasing moisture, constructability in putting in a nail and fire-safety; and was excellent in the properties such as amount of surface water absorption, elongation percentage by water absorption, carbonation shrinkage percentage, freezing-thawing resistance and wall-magnification. Also, almost no stearic acid was found in the water which drained off during dehydration.

### Regarding Example 4

In producing the bearing wall board of Example 4, 4 weight % of a refined wood pulp with a freeness of 500 ml, 6 weight % of an unrefined wood pulp with a freeness of 780 ml and 8 weight % of an unrefined waste paper and a succinic acid emulsion solution were used, wherein the stearic acid emulsion solution was added to the slurry so that the stearic acid accounted for 0.5 weight %, based on the total solid content of the slurry, which, as shown in Table 1, provided a bearing wall board with no problem in the properties such as specific gravity, moisture content, bending strength, Young's modulus in flexure, maximum amount of deflection, and shrinkage percentage by releasing moisture, constructability in putting in a nail and fire-safety; and was excellent in the properties such as amount of surface water absorption, elongation percentage by water absorption, carbonation shrinkage percentage, freezing-thawing resistance and wall-magnification. Also, almost no succinic acid was found in the water which drained off during dehydration.

### Regarding Example 5

In producing the bearing wall board of Example 5, 4 weight % of a refined wood pulp with a freeness of 500 ml, 6 weight % of an unrefined wood pulp with a freeness of 780 ml and 8 weight % of an unrefined waste paper and a succinic acid emulsion solution were used, wherein the stearic acid emulsion solution was added to the slurry so that the stearic acid accounted for 1.0 weight %, based on the total solid content of the slurry, which, as shown in Table 1, provided a bearing wall board with no problem in the properties such as specific gravity, moisture content, bending strength, Young's modulus in flexure, maximum amount of deflection, and shrinkage percentage by releasing moisture, constructability in putting in a nail and fire-safety; and was excellent in the properties such as amount of surface water absorption, elongation percentage by water absorption, carbonation shrinkage percentage, freezing-thawing resistance and wall-magnification. Also, almost no succinic acid was found in the water which drained off during dehydration.

### Regarding Example 6

In producing the bearing wall board of Example 6, 4 weight % of a refined wood pulp with a freeness of 500 ml, 6 weight % of an unrefined wood pulp with a freeness of 780 ml and 8 weight % of an unrefined waste paper and a succinic acid emulsion solution were used, wherein the stearic acid emulsion solution was added to the slurry so that the stearic acid accounted for 2.0 weight %, based on the total solid content of the slurry, which, as shown in Table 1, provided a bearing wall board with slightly lower value of specific gravity, moisture content, bending strength and Young's modulus in flexure, but with no problem in the properties such as shrinkage percentage by releasing moisture, constructability in putting in a nail and fire-safety; and was excellent in the properties such as amount of surface water absorption, elongation percentage by water absorption, carbonation shrinkage percentage, freezing-thawing resistance and wall-magnification. Also, almost no succinic acid was found in the water which drained off during dehydration.

### Regarding Example 7

In producing the bearing wall board of Example 7, the following materials are dispersed into water to make a slurry; i.e., a refined wood pulp with a freeness of 500 ml, an unrefined wood pulp with a freeness of 780 ml and an unrefined waste paper, and a stearic acid emulsion solution is added to the slurry, then after agitating, Portland cement, perlite, blast furnace slag and fly ash are added to the slurry with agitation to be uniformly dispersed to make a complete slurry, wherein each amount of the refined wood pulp with a freeness of 500 ml, the unrefined wood pulp with a freeness of 780 ml, the unrefined waste paper, and the stearic acid account for 4 weight %, 6 weight %, 8 weight % and 2.0 weight %, respectively, based on the total solid content of the complete slurry. This, as shown in Table 1, provided a bearing wall board with no problem in the properties such as specific gravity, moisture content, bending strength, Young's modulus in flexure, maximum amount of deflection, and shrinkage percentage by releasing moisture, constructability in putting in a nail and fire-safety; and was excellent in the properties such as amount of surface water absorption, elongation percentage by water absorption, carbonation shrinkage percentage, freezing-thawing resistance and wall-magnification. Also, almost no stearic acid was found in the water which drained off during dehydration.

### Regarding Example 8

In producing the bearing wall board of Example 8, the following materials are dispersed into water to make a slurry; i.e., a refined wood pulp with a freeness of 500 ml, an unrefined wood pulp with a freeness of 780 ml and an unrefined waste paper, and a succinic acid emulsion solution is added to the slurry, then after agitating, Portland cement, perlite, blast furnace slag and fly ash are added to the slurry with agitation to be uniformly dispersed to make a complete slurry, wherein each amount of the refined wood pulp with a freeness of 500 ml, the unrefined wood pulp with a freeness of 780 ml, the unrefined waste paper, and the succinic acid accounts for 4 weight %, 6 weight %, 8 weight % and 2.0 weight %, respectively, based on the total solid content of the complete slurry. This, as shown in Table 1, provided a bearing wall board with no problem in the properties such as specific gravity, moisture content, bending strength, Young's modulus in flexure, maximum amount of deflection, and shrinkage percentage by releasing moisture, constructability in putting in a nail and fire-safety; and was excellent in the properties such as amount of surface water absorption, elongation percentage by water absorption, carbonation shrinkage percentage, freezing-thawing resistance and wall-magnification. Also, almost no succinic acid was found in the water which drained off during dehydration.

### Regarding Comparison Example 1

In producing an inorganic board in Comparison Example 1, a refined wood pulp with a freeness of 500 ml, an unrefined wood pulp with a freeness of 780 ml and an unrefined waste paper were used but no saturated carboxylic acid emulsion solution was used, which, as shown in Table 1, provided a bearing wall board with no problem in the properties such as specific gravity, moisture content, bending strength, Young's modulus in flexure, maximum amount of deflection, shrinkage percentage by releasing moisture, constructability in putting in a nail and fire-safety; and which was excellent in wall-magnification; but which was poor in the properties such as amount of surface water absorption, elongation percentage by water absorption, carbonation shrinkage percentage, and freezing-thawing resistance.

### Regarding Comparison Example 2

In producing the bearing wall board of Comparison Example 2, 4 weight % of a refined wood pulp with a freeness of 500 ml, 6 weight % of an unrefined wood pulp with a freeness of 780 ml and 8 weight % of an unrefined waste paper and a stearic acid emulsion solution were used, wherein the stearic acid emulsion solution was added to the slurry so that the stearic acid accounted for 3.0 weight %, based on the total solid content of the slurry, which, as shown in Table 1, provided a bearing wall board with no problem in the properties such as specific gravity, moisture content, constructability in putting in a nail and fire-safety; and which was excellent in the properties such as amount of surface water absorption, elongation percentage by water absorption, carbonation shrinkage percentage and wall-magnification, but which was poor in bending strength, Young's modulus in flexure, maximum amount of deflection, shrinkage percentage by releasing moisture and freezing-thawing resistance. Also, stearic acid was found in the water which drained off during dehydration.

### Regarding Comparison Example 3

In producing the bearing wall board of Comparison Example 3, 4 weight % of a refined wood pulp with a freeness of 500 ml, 6 weight % of an unrefined wood pulp with a freeness of 780 ml and 8 weight % of an unrefined waste paper and a succinic acid emulsion solution were used, wherein the succinic acid emulsion solution was added to the slurry so that the succinic acid accounted for 3.0 weight %, based on the total solid content of the slurry, which, as shown in Table 1, provided a bearing wall board with no problem in the properties such as wall-magnification, constructability in putting in a nail and fire-safety; and which was excellent in the properties such as amount of surface water absorption, and carbonation shrinkage percentage, but which was poor in bending strength, Young's modulus in flexure, maximum amount of deflection, elongation percentage by water absorption, shrinkage percentage by releasing moisture and freezing-thawing resistance. Also, succinic acid was found in the water which drained off during dehydration.

### Regarding Comparison Example 4

In producing the bearing wall board of Comparison Example 4, 4 weight % of a refined wood pulp with a freeness of 500 ml, 6 weight % of an unrefined wood pulp with a freeness of 780 ml and 8 weight % of an unrefined waste paper and a paraffin solution were used, wherein the paraffin solution was added to the slurry so that the paraffin accounted for 1.0 weight %, based on the total solid content of the slurry, which, as shown in Table 1, provided a bearing wall board with no problem in the properties such as specific gravity, moisture content, constructability in putting in a nail and fire-safety; and which was excellent in the properties such as amount of surface water absorption, but which was poor in bending strength, Young's modulus in flexure, maximum amount of deflection, elongation percentage by water absorption, shrinkage percentage by releasing moisture, carbonation shrinkage percentage, freezing-thawing resistance and wall-magnification. Also, paraffin was found in the water which drained off during dehydration.

### Regarding Comparison Example 5

In producing the bearing wall board of Comparison Example 5, 10 weight % of an unrefined wood pulp with a freeness of 780 ml and 8 weight % of an unrefined waste paper and a stearic acid emulsion solution were used, wherein the stearic acid emulsion solution was added to the slurry so that the stearic acid accounted for 0.5 weight %, based on the total solid content of the slurry, which, as shown in Table 1, provided a bearing wall board with no problem in the properties such as specific gravity, moisture content, Young's modulus in flexure, maximum amount of deflection, constructability in putting in a nail and fire-safety; and which was excellent in the properties such as wall-magnification, but which was slightly lower in bending strength and which was poor in amount of surface water absorption, elongation percentage by water absorption, shrinkage percentage by releasing moisture, carbonation shrinkage percentage and freezing-thawing resistance. Also, stearic acid was found in the water which drained off during dehydration.

### Regarding Comparison Example 6

In producing the bearing wall board of Comparison Example 6, 10 weight % of an unrefined wood pulp with a freeness of 780 ml and 8 weight % of an unrefined waste paper and a succinic acid emulsion solution were used, wherein the succinic acid emulsion solution was added to the slurry so that the succinic acid accounted for 0.5 weight %, based on the total solid content of the slurry, which, as shown in Table 1, provided a bearing wall board with no problem in the properties such as specific gravity, moisture content, bending strength, Young's modulus in flexure, maximum amount of deflection, shrinkage percentage by releasing moisture, constructability in putting in a nail and fire-safety; and which was excellent in the properties such as wall-magnification, but which was poor in amount of surface water absorption, elongation percentage by water absorption, carbonation shrinkage percentage and freezing-thawing resistance. Also, succinic acid was found in the water which drained off during dehydration.

### Regarding Comparison Example 7

In producing the bearing wall board of Comparison Example 7, 7 weight % of a refined wood pulp with a freeness of 500 ml, 6 weight % of an unrefined wood pulp with a freeness of 780 ml and 8 weight % of an unrefined waste paper and a stearic acid emulsion solution were used, wherein the stearic acid emulsion solution was added to the slurry so that the stearic acid accounted for 0.5 weight %, based on the total solid content of the slurry, which, as shown in Table 1, provided a bearing wall board that was poor in specific gravity, moisture content, bending strength, Young's modulus in flexure, maximum amount of deflection, amount of surface water absorption, elongation percentage by water absorption, shrinkage percentage by releasing moisture, carbonation shrinkage percentage, freezing thawing resistance, wall-magnification and fire-safety. Also, almost no stearic acid was found in the water which drained off during dehydration.

### Regarding Comparison Example 8

In producing the bearing wall board of Comparison Example 8, 7 weight % of a refined wood pulp with a freeness of 500 ml, 6 weight % of an unrefined wood pulp with a freeness of 780 ml and 8 weight % of an unrefined waste paper and a succinic acid emulsion solution were used, wherein the succinic acid emulsion solution was added to the slurry so that the succinic acid accounted for 0.5 weight %, based on the total solid content of the slurry, which, as shown in Table 1, provided a bearing wall board that was poor in specific gravity, moisture content, bending strength, Young's modulus in flexure, maximum amount of deflection, amount of surface water absorption, elongation percentage by water absorption, shrinkage percentage by releasing moisture, carbonation shrinkage percentage, freezing-thawing resistance, wall-magnification and fire-safety. Also, almost no succinic acid was found in the water which drained off during dehydration.

As explained above, a bearing wall board produced by the method of the present invention has an improved workability since the board is excellent in strength, bending and constructability in putting in a nail, in addition to a low specific gravity of 1.0 or less, obtained without deteriorating the fire-safety property thereof. The board has a wall-magnification of 2.5 or more, i.e., high earthquake resistance. Also in the board of this invention, calcium hydrate and fiber reinforcing materials are coated with saturated carboxylic acid, which prevents/protects the board from water absorption, dimensional change and carbonation shrinkage, and which secures water resistance, dimensional stability and freezing resistance for the long term. Further, in the manufacturing method of the present invention, production troubles such as the surfacing of the water-repellent agent and/or foaming can be prevented, and moreover the use of a small amount of carboxylic acid can work well in the invention.

What is claimed is:

1. A bearing wall board, comprising:
a cement-based hydraulic material, a fiber reinforcing material, a lightweight aggregate, and a saturated carboxylic acid.

2. The bearing wall board according to claim 1, wherein:
the cement-based hydraulic material is contained in the bearing wall board in an amount of 20 weight % or more and 60 weight % or less, based on the total solid content of the bearing wall board,
the fiber reinforcing material is contained in the bearing wall board in an amount of 6 weight % or more and 20 weight % or less, based on the total solid content of the bearing wall board,
the lightweight aggregate is contained in the bearing wall board in an amount of 3 weight % or more and 18 weight % or less, based on the total solid content of the bearing wall board, and
the saturated carboxylic acid is contained in the bearing wall board in an amount of by 0.1 weight % or more and 2.0 weight % or less, based on the total solid content of the bearing wall board.

3. The bearing wall board according to claim 1, wherein the fiber reinforcing material comprises a refined fiber with a freeness of 650 ml or less and an unrefined fiber.

4. The bearing wall board according to claim 2, wherein the fiber reinforcing material comprises a refined fiber with a freeness of 650 ml or less and an unrefined fiber.

5. The bearing wall board according to claim 1, wherein the saturated carboxylic acid is a stearic acid-based carboxylic acid or a succinic acid-based carboxylic acid.

6. The bearing wall board according to claim 2, wherein the saturated carboxylic acid is a stearic acid-based carboxylic acid or a succinic acid-based carboxylic acid.

7. The bearing wall board according to claim 3, wherein the saturated carboxylic acid is a stearic acid-based carboxylic acid or a succinic acid-based carboxylic acid.

8. The bearing wall board according to claim 4, wherein the saturated carboxylic acid is a stearic acid-based carboxylic acid or a succinic acid-based carboxylic acid.

9. A method for producing a bearing wall board, comprising steps of:
preparing a slurry by dispersing a cement-based hydraulic material, a refined fiber with a freeness of 650 ml or less, an unrefined fiber and a lightweight aggregate into water,
adding a saturated carboxylic acid to the slurry, and then
forming the slurry into a sheet,
dehydrating the sheet,
pressing the sheet and curing the sheet.

10. The method for producing a bearing wall board according to claim 9, wherein the saturated carboxylic acid is a stearic acid-based carboxylic acid or a succinic acid-based carboxylic acid

11. A method for producing a bearing wall board, comprising steps of:
preparing a slurry by dispersing a refined fiber with a freeness of 650 ml or less and an unrefined fiber into water,
adding a saturated carboxylic acid to the slurry,
agitating the slurry, and then
dispersing a cement-based hydraulic material and a lightweight aggregate into the slurry to form a complete slurry, and
forming the complete slurry into a sheet,
dehydrating the sheet,
pressing the sheet and
curing the sheet.

12. The method for producing a bearing wall board according to claim 11, wherein the saturated carboxylic acid is a stearic acid-based carboxylic acid or a succinic acid-based carboxylic acid.
